(19) United States
(12) Patent Application Publication
(10) Pub. No.: US 2013/0054659 A1
(43) Pub. Date: Feb. 28, 2013

(54) INFORMATION PROCESSING TECHNIQUE FOR OPTIMIZATION

(71) Applicants: Hitoshi YANAMI, Kawasaki (JP); Hirokazu ANAI, Hachioji (JP); Hidenao IWANE, Kawasaki (JP)

(72) Inventors: Hitoshi YANAMI, Kawasaki (JP); Hirokazu ANAI, Hachioji (JP); Hidenao IWANE, Kawasaki (JP)

(73) Assignee: FUJITSU LIMITED, Kawasaki-shi (JP)

(21) Appl. No.: 13/591,314

(22) Filed: Aug. 22, 2012

(30) Foreign Application Priority Data
Aug. 29, 2011 (JP) 2011-185575

(51) Int. Cl. G06F 7/00

(52) U.S. Cl. 708/200

(57) ABSTRACT

The disclosed method includes: generating a problem for a quantifier elimination (QE) method from a cost function representing a relationship between a parameter set and a cost; executing, by a module that executes a processing for the QE method by term substitution, a processing for the problem, to obtain a first processing result; when the first processing result includes a first partial problem for which the term substitution is impossible, executing, by a module that execute a numerical analysis processing, a processing to minimize the cost for the first partial problem, to obtain a second processing result; when the first processing result includes a logical expression as a solution of a second partial problem for which the term substitution has been completed, generating data to identify a minimum cost value from the logical expression; and generating a minimum cost for the problem from at least the second processing result.

### CROSS-REFERENCE TO RELATED APPLICATIONS

This application is based upon and claims the benefit of priority of the prior Japanese Patent Application No. 2011-185575, filed on Aug. 29, 2011, the entire contents of which are incorporated herein by reference.

### FIELD

This technique relates to a technique of optimized calculation.

### BACKGROUND

For example, at a design stage of the product, a processing is carried out to calculate values of parameters so as to minimize a value of an objective function (also called “cost function”) of the parameters, which represents design requirements.

For example, when the parameters are normalized, and the normalized parameters vary between 0 and 1, the search space corresponds to a unit hypercube, and one point in this unit hypercube corresponds to one designed shape.

In order to solve such a problem, there are methods using a numerical analysis processing and a method using computer algebra.

In the method using the numerical analysis processing, after determining the basic shape, parameters for changing the shape are set, and the parameters are changed so as to minimize the value of the objective function. At that time, the number of parameters increases and the search space becomes large, when various shapes are handled in one numerical analysis processing. Therefore, there are problems such as the processing time required for the numerical analysis processing may become long, or only a localized solution may be obtained.

On the other hand, in the method using computer algebra, a feasible region is obtained by carrying out the following processing to obtain data of the minimum cost value from the feasible region. Specifically, after determining the basic shape, parameters for changing the shape are set, data concerning association between the parameters and costs (i.e. values of the objective function) are collected to generate an expression representing the association, and the feasible region is obtained by solving a constraint expression obtained by the generated expression, the parameters and the like, by the quantifier elimination (QE) method. When symbolic computation with a computer algebra system is carried out, the feasible region in the form of the logical expression is obtained, and the optimum value is accurately obtained. However, by using symbolic methods the computation may not be completed within an allowable period, and information about the solution may not completely be obtained.

In addition, there is a computer algebra system for rapidly conducting symbolic computation in case of solving systems of linear equations appeared when carrying out simulation of large-scale circuits. More specifically, a computer algebra system for conducting symbolic computation to solve the system of the linear equations by conducting the symbolic computation and numerical calculation using results of the symbolic computation has following elements. Namely the system has (A) matrix dividing means for dividing a matrix representing system of the linear equations to be solved into plural line groups each having at least one line of the matrix, (B) plural first entry adding means, each of which corresponds to each of the line groups obtained by the division by the matrix dividing means, for adding an entry of an element, which is included in its own line group and whose value is not “0”, to an entry group corresponding to that line group, (C) pivot selecting means for sequentially calculating a second variable whose number of calculation times required when eliminating a variable represented by a first variable which sequentially varies from 1 to the number of lines in the matrix becomes minimum, (D) pivot exchange means for respectively exchanging a line indicated by the first variable in the matrix and a line indicated by the second variable, and a column indicated by the first variable in the matrix and a column indicated by the second variable, (E) plural second entry adding means, each of which corresponds to one corresponding first entry adding means, for obtaining, for each corresponding line group, acquiring fill-in which occurs when eliminating the variable in the matrix whose line and column are exchanged by the pivot exchange means, and further adding the entry of the fill-in to the entry group for which each entry is added by the corresponding first entry adding means, and (F) matrix compressing means for compressing the matrix by using plural entry groups to which the entries are added by the first and second entry adding means. However, a case where the symbolic computation cannot be conducted is not considered.

In other words, there is no technique for rapidly calculating appropriate solutions even when no information concerning solutions can be obtained by the computer algebra within the allowable time.

### SUMMARY

An information processing method relating to this technique includes: (A) first generating a problem for a quantifier elimination method from data of a cost function representing a relationship between a parameter set and a cost; (B) causing a first module that carries out a processing for the quantifier elimination method by term substitution to carry out the processing for the generated problem, to obtain a first processing result; (C) upon detecting that the first processing result includes data of a first partial problem for which the term substitution is impossible, causing a second module that carries out a numerical analysis processing to carry out a processing to minimize a cost for the first partial problem, to obtain a second processing result; (D) upon detecting that the first processing result includes a logical expression that is a solution of a second partial problem for which the term substitution has been completed, second generating first data to identify a minimum cost value from the logical expression; and (E) third generating second data representing a minimum cost for the problem from the second processing result and the first data generated when the second partial problem exists.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram of an information processing apparatus relating to an embodiment of this technique;

FIG. 2 is a diagram depicting a processing flow relating to the embodiment of this technique;

FIG. 3A is a diagram depicting an example of data stored in a parameter value storage unit;

FIG. 3B is a diagram depicting an example of data stored in a first cost data storage unit;

FIG. 3C is a diagram schematically depicting association between parameters and costs;

FIG. 4 is a diagram to explain quantifier elimination by term substitution;

FIG. 5 is a diagram schematically depicting a value range of a cost, which is identified from a logical expression of a solution;

FIG. 6 is a diagram schematically depicting a processing to identify a minimum cost value; and

FIG. 7 is a functional block diagram of a computer.

### DESCRIPTION OF EMBODIMENTS

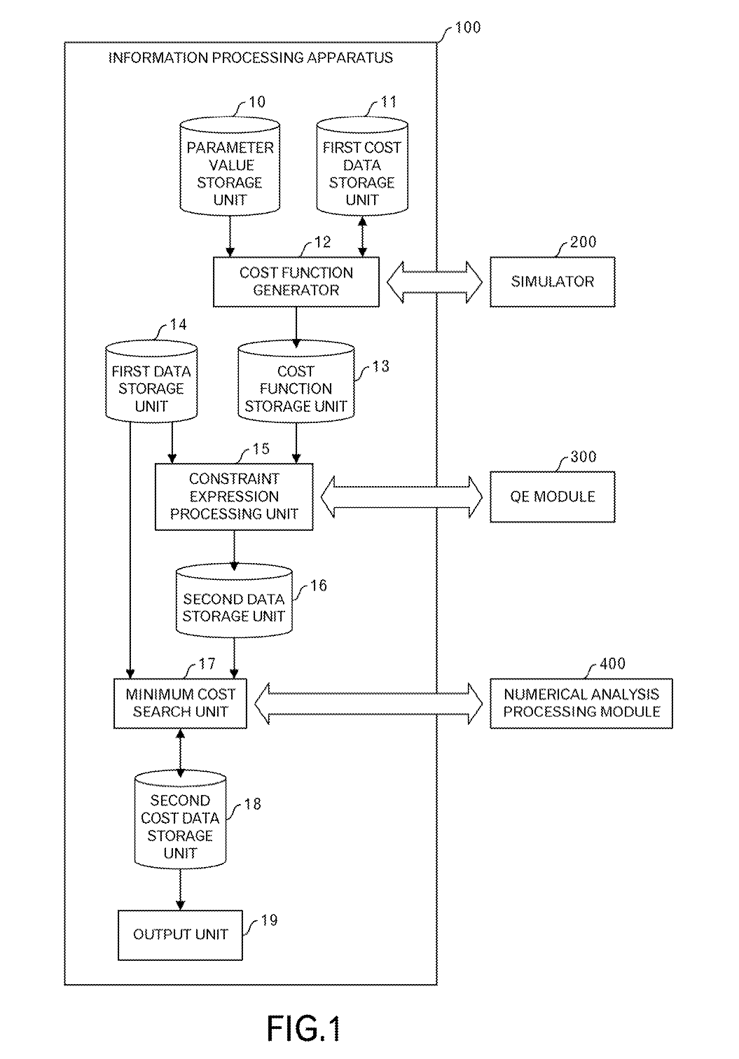

FIG. 1 illustrates a functional block diagram of an information processing apparatus 100 relating to an embodiment of this technique. The information processing apparatus 100 relating to this embodiment has a parameter value storage unit 10, first cost data storage unit 11, cost function generator 12, cost function storage unit 13, first data storage unit 14, constraint expression processing unit 15, second data storage unit 16, minimum cost search unit 17, second cost data storage unit 18 and output unit 19.

The parameter value storage unit 10 stores plural sets of parameter values for plural design parameters. Moreover, the first cost data storage unit 11 stores plural sets of cost values of respective costs corresponding to the parameter value set stored in the parameter value storage unit 10. The cost function generator 12 generates an approximate expression of the cost function by using data stored in the parameter value storage unit 10 and first cost data storage unit 11, and stores data of the approximate expression into the cost function storage unit 13. The cost function generator 12 may cooperate with a simulator 200 implemented in the same or different apparatus (typically computer). The simulator 200 has a function to calculate various kinds of cost values when inputting the parameter value set of the design parameters, for example. This function has already existed. Therefore, further explanation is omitted.

The first data storage unit 14 stores data of constraint conditions such as variable ranges in the design parameter space, and constraint conditions of the cost and other parameters. Moreover, the constraint expression processing unit 15 generates a constraint expression that is a QE problem by using data stored in the cost function storage unit 13 and first data storage unit 14, carries out a processing by cooperating with the QE module 300 implemented in the same or different apparatus to obtain processing results, and stores the obtained processing results into the second data storage unit 16.

The QE module 300 carries out symbolic computation according to the quantifier elimination method by the term substitution. For example, this QE module 300 generates an equivalent expression in which the quantifiers (∃ and ∀) are eliminated from the constraint expression ∃b∀x (x²+bx+c>0) regarding real numbers x, b and c. Incidentally, the variables with ∃ and ∀ are called “quantified variables”, and the variables without quantifiers are called “free variables”.

Specifically, in case of F=∃b∀x (x²+bx+c>0), ∀x (x²+bx+c>0) is firstly solved to obtain b²−4c<0. Then, by solving ∃b (b²−4c<0), c>0 is obtained. Thus, a processing to eliminate the variables x and b one-by-one is carried out. In actual, the logical expression frequently becomes longer every time one variable is eliminated as follows:
∃x∀y∃z (logical expression including x, y, z and free variables)
∃x∀y (“long” logical expression including x, y and free variables)
∃x (“very long” logical expression including x and free variables)

Therefore, there is a case where the calculation is not completed within the allowable time.

The QE module 300 relating to this embodiment divides and solves the problem of the constraint expression generated by the constraint expression processing unit 15 into partial problems while carrying out the term substitution step-by-step, and outputs, as processing results, the partial problem for which the term substitution cannot be made within a predetermined time and outputs solutions (specifically, logical expressions representing feasible regions) for the partial problems for which the term substitution can be made within the predetermined time.

The minimum cost search unit 17 carries out a processing to search the minimum cost value and the like by using data such as the processing results of the QE module 300, which are stored in the second data storage unit 16, and constraint conditions stored in the first data storage unit 14.

Incidentally, as for the general QE technique, refer to the following documents. However, because a lot of documents for the QE method exist, useful documents other than the following documents exist. These documents are incorporated herein by reference.

Anai Hirokazu and Yokoyama Kazuhiro, “Introduction to Computational Real Algebraic Geometry”, Mathematics Seminar, Nippon-Hyoron-sha Co., Ltd., “Series No. 1”, Vol. 554, pp. 64-70, November, 2007, “Series No. 2”, Vol. 555, pp. 75-81, December, 2007, “Series No. 3”, Vol. 556, pp. 76-83, January, 2008, “Series No. 4”, Vol. 558, pp. 79-85, March, 2008, “Series No. 5”, Vol. 559, pp. 82-89, April, 2008.

Anai Hirokazu, Kaneko Junji, Yanami Hitoshi and Iwane Hidenao, “Design Technology Based on Symbolic Computation”, FUJITSU, Vol. 60, No. 5, pp. 514-521, September, 2009.

Jirstrand Mats, “Cylindrical Algebraic Decomposition—an Introduction”, Oct. 18, 1995.

The aforementioned QE module 300 outputs the solutions for the partial problems for which the term substitution can be made, and outputs the logical expressions representing the partial problem for which the term substitution cannot be completed. In this embodiment, the minimum cost search unit 17 causes the numerical analysis processing module 400 that is implemented in the same or difference apparatus to carry out a processing to minimize the cost for the logical expression representing the partial problems for which the term substitution cannot be completed, and obtains processing results from the numerical analysis processing module 400, and stores the processing results into the second cost data storage unit 18. As for the partial problems for which the term substitution cannot be completed within the allowable time, because a portion of the variables has been eliminated or a logical expression for which the term substitution should be carried out has been determined for the variables to be eliminated, the number of variables is substantially reduced, and the entire search range is narrowed. Therefore, the processing time can be shortened, compared with a case where the minimum cost value is searched by the numerical analysis from the initial step. In addition, the minimum cost search unit 17 generates data to identify the minimum cost value for the logical expression representing the feasible region, and stores the generated data into the second cost data storage unit 18. The output unit 19 outputs data stored in the second cost data storage unit 18 to an output device (e.g. display device and/or printer).

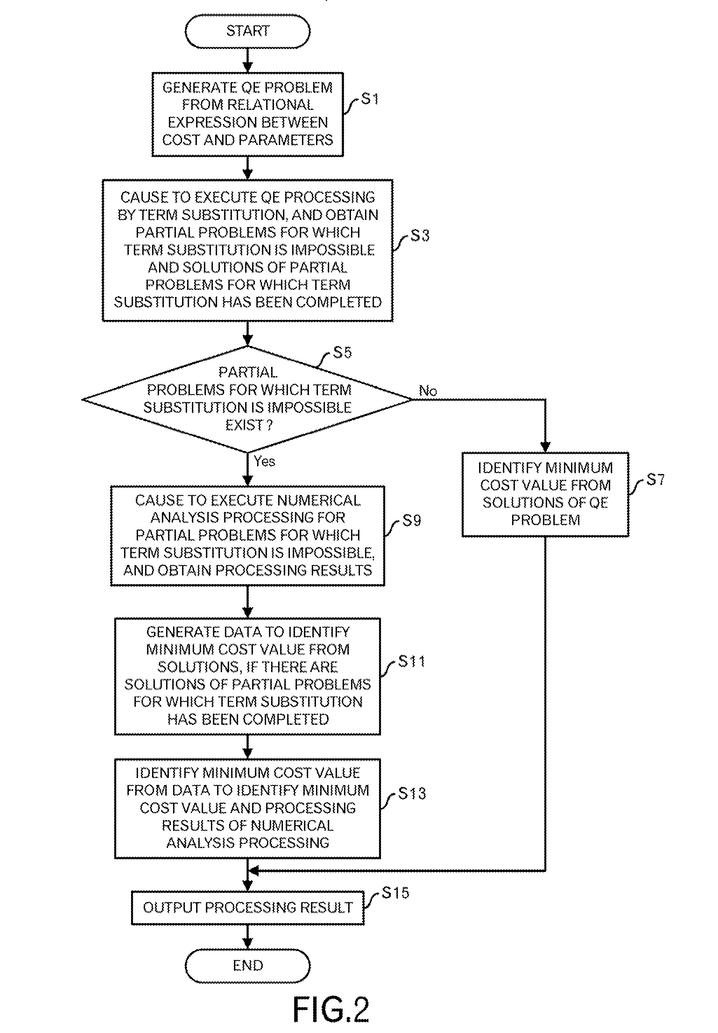

Next, processing contents of the information processing apparatus 100 illustrated in FIG. 1 will be explained by using FIGS. 2 to 6. First, the cost function generator 12 and constraint expression processing unit 15 generate a QE problem from the relational expressions between the cost and parameters, and stores data of the QE problem into a storage device such as a main memory (FIG. 2: step S1).

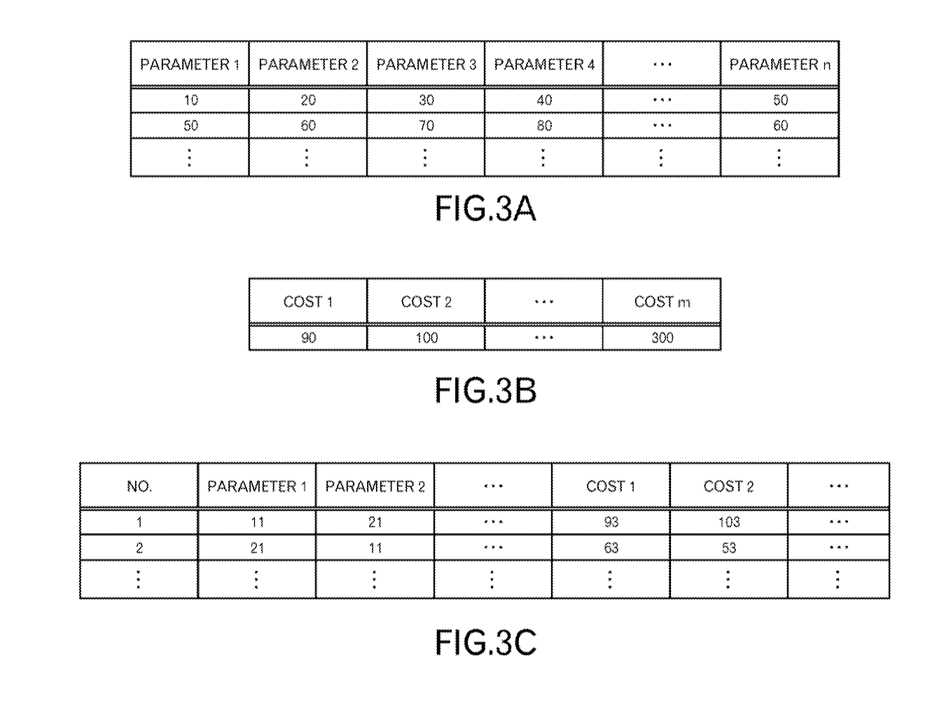

More specifically, the cost function generator 12 obtains plural combinations, each including the parameter value set for the plural design parameters and a corresponding cost value (plural cost values when plural costs are handled.), calculates an approximate expression of the cost function, and stores data of the expression into the cost function storage unit 13. The parameter value set for the plural design parameters has been stored in the parameter value storage unit 10. For example, data as illustrated in FIG. 3A has been stored in the parameter value storage unit 10. Instead of the parameter value sets themselves, expressions or rules to generate the parameter value sets maybe stored. For example, within predefined variable ranges of the design parameters, the parameter values may be generated randomly, or may be regularly generated at regular intervals.

In addition, the corresponding cost values have been stored in the first cost data storage unit 11 when they have been prepared in advance. For example, when plural costs are handled, data as illustrated in FIG. 3B has been stored in the first cost data storage unit 11. On the other hand, when the cost values have not been prepared, the cost function generator 12 inputs the parameter value set stored in the parameter value storage unit 10, causes the simulator 200 to generate the corresponding cost values, obtains the cost values from the simulator 200, and stores the obtained cost values into the first cost data storage unit 11. By carrying out such a processing for each parameter value set stored in the parameter value storage unit 10, plural corresponding cost value sets can be obtained. Namely, as illustrated in FIG. 3C, values of parameters 1 to n are associated with values of costs 1 to m (in case where plural cost values are handled). However, n and m are integers equal to or greater than 2.

The approximate expression of the cost function is derived by using a well-known method such as multiple regression from the plural parameter value sets and corresponding cost value sets. However, instead of the multiple regression, other method such as polynomial approximation technique may be adopted.

Then, the constraint expression processing unit 15 generates a constraint expression as an input to the QE module 300, from the data of the constraint conditions such as the design parameter values, which are stored in the first data storage unit 14, and the cost function stored in the cost function storage unit 13.

In this embodiment, when the approximate expression f=F (x, y, z) is calculated or the design parameter x, y and z, and the constraint conditions of the design parameters and the like are represented by φ (x, y, z), the constraint expression as a QE problem, is expressed as follows:

∃z∃y∃x (f−F(x, y, z)=0 φ (x, y, z))

Then, the constraint expression processing unit 15 outputs data of the constraint expression as generated above to the QE module 300, causes the QE module 300 to carry out the QE processing by the term substitution, obtains data of the partial problems for which the term substitution cannot be completed within a predetermined time and solutions of the partial problems for which the term substitution has been completed, and stores the obtained data into the second data storage unit 16 (step S3).

Here, the outline of the QE processing by the term substitution will be explained. As indicated in the first line of the following expression, a case will be considered that a constraint expression for the logical expression including x and free variables is solved. Such a constraint expression can be expressed by the second line. However, R is a set (i.e. infinite set) of the entire real numbers, and cannot be converted, substantially. However, as further indicated in the third line, even when a term t included in a set (i.e. finite set) S including terms of the free variables substituted for x, the constraint expression in the third line is equivalent to the constraint expression in the first line. The term t is expressed by variables other than x. Therefore, x can be eliminated when the term t is substituted for x. In case of S={t1, t2, t3, . . . , ts}, as indicated in the fourth line, the constraint expression can be divided into plural expression coupled by OR (i.e. logical sum).

$$∃ x ( logical expression including x and free variables ) ⇔ {}_{r ∈ R} ( logical expression in which x is substituted for real number r ) ⇔ {}_{t ∈ S} ( logical expression in which x is substituted for term t ) ⇔ ( logical expression in which term t 1 is substituted for x ) ( logical expression in which term t 2 is substituted for x ) … ( logical expression in which term ts is substituted for x )$$

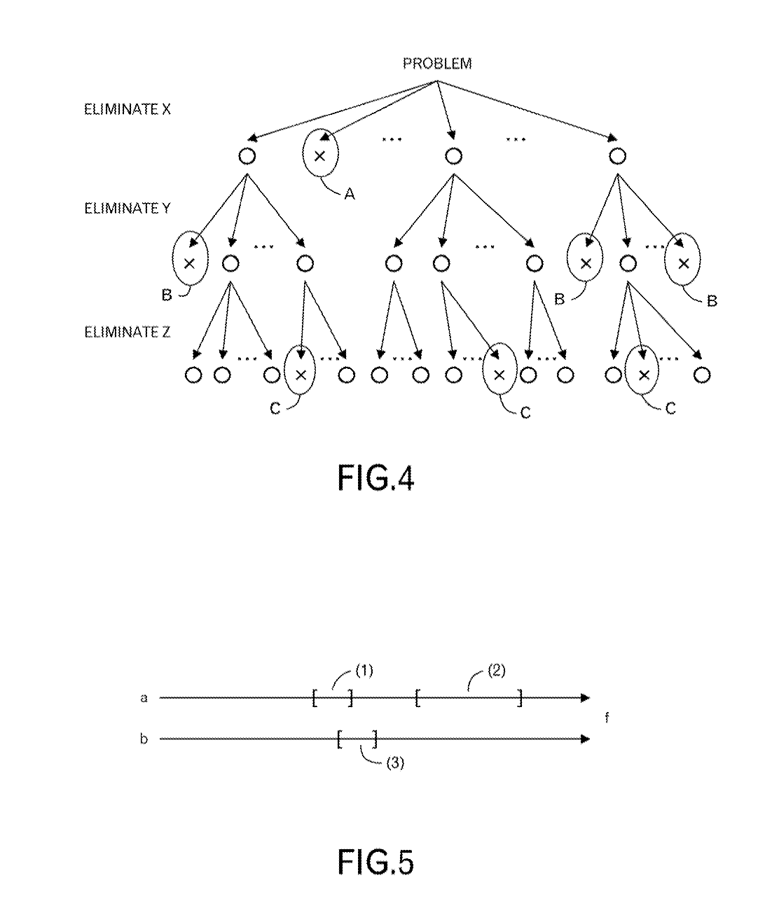

The QE module 300 that carries out the aforementioned QE processing by the term substitution processes ∃z∃y∃x (i.e. logical expression including the variables x, y and z with the quantifier and free variables f and the like) as schematically illustrated in FIG. 4. In other words, when eliminating x, the initial problem is divided into plural partial problems by substituting t1 to ts for x. In the example of FIG. 4, as indicated by X at A placed at a tip of the second arrow from the left, it is assumed that t2 cannot be substituted for x within the predetermined time. Therefore, when eliminating x, the partial problem to substitute t2 for x in the original problem is outputted from the QE module 300 to the constraint expression processing unit 15 as a partial problem for which the term substitution cannot be completed.

Furthermore, as for the partial problems in which x can be eliminated as illustrated by a circle mark, it is assumed that, at the stage for eliminating y, as illustrated by X at three Bs, uᵢ, which corresponds to tᵢ after eliminating x, cannot be substituted for y within the predetermined time. Therefore, at the stage to eliminate y, the partial problems to substitute uᵢ for y in the partial problems in which x has been eliminated are outputted from the QE module 300 to the constraint expression processing unit 15 as the partial problem for which the term substitution cannot be completed.

Furthermore, as for the partial problems in which x and y can be eliminated as illustrated by circle marks, it is assumed that, at the stage to eliminate z, as illustrated by X at three Cs, vⱼ, which corresponds to tᵢ after eliminating x and y, cannot be substituted for z within the predetermined time. Therefore, at the stage to eliminate z, the partial problem to substitute vⱼ for z in the partial problems in which x and y have been eliminated are outputted from the QE module 300 to the constraint expression processing unit 15 as the partial problems for which the term substitution cannot be completed. Incidentally, as for the partial problem in which x, y and z have been eliminated as illustrated by circle marks at the lowest stage, the logical expression in which x, y and z have been eliminated is obtained as solutions of partial problems. Therefore, the logical expression in which x, y and z have been eliminated is outputted from the QE module 300 to the constraint expression processing unit 15.

As for the partial problem to substitute t2 for x in the original problem, the search for y, z and free variables will be carried out according to the constraint conditions stored in the first data storage unit 14. In other words, the search range is narrowed.

As for the partial problem to substitute uᵢ for y in the partial problem in which x has been eliminated, the search for z and free variables will be carried out according to the constraint conditions stored in the first data storage unit 14. In other words, the search range is narrowed.

Furthermore, as for the partial problem to substitute vⱼ for z in the partial problem in which x and y have been eliminated, the search for the free variables will be carried out according to the constraint conditions stored in the first data storage unit 14. In other words, the search range is narrowed.

Thus, the QE module 300 does not return the result representing that the processing is impossible when the term substitution cannot partially be completed. Namely, the QE module 300 carries out the next term substitution for the partial problem for which the term substitution can be completed, and returns data concerning the partial problem for which the term substitution cannot be completed. When all variables with the quantifier can be eliminated, the logical expression of the solution of the partial problem is returned.

Next, the minimum cost search unit 17 determines whether or not data of the partial problems for which the term substitution is impossible is included in the processing results of the QE module 300, which are stored in the second data storage unit 16 (step S5). When the data of the partial problems for which the term substitution is impossible is not included in the processing results of QE module 300, in other words, when the logical expression of the solutions of the original problem is obtained, the normal symbolic computation has been completed. In such a case, the minimum cost search unit 17 identifies the minimum value of the cost function from the logical expression of the solution of the original problem, and stores data of the minimum value of the cost function into the second cost data storage unit 18 (step S7). Then, the processing shifts to step S15.

For example, when Φ (f) is obtained as a solution of ∃z∃y∃x (f−F (x, y, z)=0 φ (x, y, z)), the feasible region of the cost f is obtained. Therefore, the minimum value of Φ (f) is identified. Φ (f) is typically represented by the logical sum of plural expressions. As schematically illustrated in FIG. 5, in case of the logical sum of two expressions, from value ranges (1) and (2) of “f”, which are identified from the expression “a”, a value range (3) of “f”, which is identified from the expression “b”, the lower limit value of the value range (1) is identified as the minimum cost value. Incidentally, it is assumed that the cost f becomes greater value in the right direction of FIG. 5.

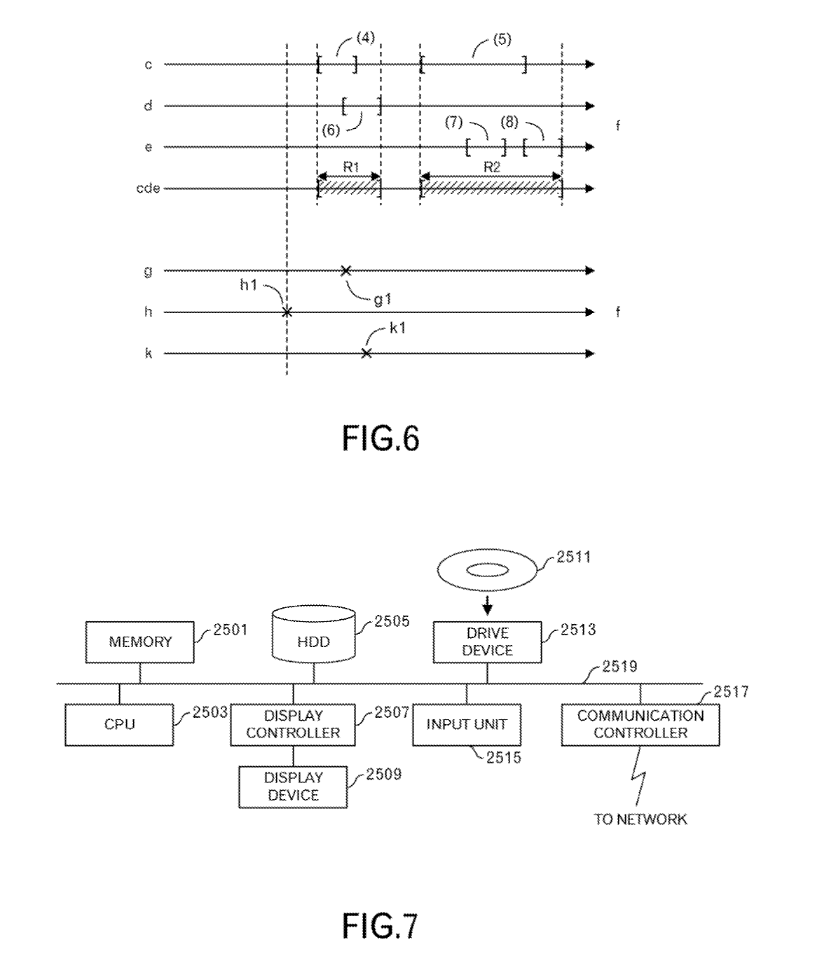

On the other hand, when the processing results of the QE module 300 include the partial problem for which the term substitution cannot be completed, the minimum cost search unit 17 outputs data of the partial problem for which the term substitution cannot be completed to the numerical analysis processing module 400, and causes the numerical analysis processing module 400 to search for the minimum cost value. There are various known numerical optimization methods for searching for the minimum cost value, and any method may be used. Then, the minimum cost search unit 17 obtains the processing results from the numerical analysis processing module 400, and stores data of the obtained processing result into the second cost data storage unit 18 (step S9). When there are plural partial problems for which the term substitution cannot be completed, the minimum cost value is obtained for each partial problem. For example, when there are the partial problems g, h and k for which the term substitution cannot be completed, as illustrated at the lower stage of FIG. 6, it is assumed that the minimum cost values g1, h1 and k1 are obtained. Incidentally, the cost f becomes greater value in the right direction also in FIG. 6.

Furthermore, when the processing result of the QE module 300, which is stored in the second data storage unit 16, includes the logical expression of the solution of the partial problem for which the term substitution has been carried out, the minimum cost search unit 17 generates data to identify the minimum cost value from the logical expression of the solution, and stores the generated data into the second cost data storage unit 18 (step S11). For example, as illustrated at the top stage of FIG. 6, it is assumed that the value ranges (4) and (5) of the cost f for the logical expression “c” of the solution of the partial problem, the value range (6) of the cost f for the logical expression “d” of the solution of the partial problem and the value ranges (7) and (8) of the cost f for the logical expression “e” of the solution of the partial problem are obtained. Then, when summarizing these solutions of the partial problems, value ranges R1 and R2 are obtained as illustrated in the line cde of FIG. 6. This step may be a processing to identify such value ranges R1 and R2 or a processing to identify the lower limit value of the value ranges R1 and R2.

Incidentally, there is a case where the logical expression of the solution of the partial problem for which the term substitution has been completed does not exist. This means that the term substitution failed at any stage. However, because the search range is narrowed in any case, the processing time for the numerical analysis processing can be shortened.

In addition, the minimum cost search unit 17 identifies the minimum cost value from the processing result of the numerical analysis processing at the step S9, data to identify the minimum cost value at the step S11 when there is the logical expression of the solution of the partial problem for which the term substitution has been completed, and stores the minimum cost value into the second cost data storage unit 18 (step S13). In the example of FIG. 6, because h1 obtained by the numerical analysis processing is less than the lower limit value of the value range R1 in the line cde, h1 is identified as the minimum cost value. Data of this minimum cost value h1 is stored in the second cost data storage unit 18.

Incidentally, when the value obtained by the numerical analysis processing is identified as the minimum cost value, it may not be a true minimum cost value. In other words, when the problem could be solved by symbolic computation, a value range including lesser value might be obtained.

In addition, when there is no solution of the partial problem for which the term substitution has been completed, data at the top stage of FIG. 6 does not exist, and the minimum cost value is identified from the processing of the numerical analysis processing at the lower stage of FIG. 6.

The output unit 19 outputs data of the minimum cost value, which is stored in the second cost data storage unit 18, to an output device (step S15).

By carrying out the aforementioned processing, the minimum cost value can be obtained by the numerical analysis processing in which the number of variables to be searched is reduced even for the partial problem that cannot be solved by the computer algebra. Therefore, as a whole, the processing time can be reduced and the solution can be obtained.

Incidentally, in the above explanation, an example was explained in which one cost function f was used. In such a case, one minimum cost value can be identified. However, when two or more kinds of costs are handled, the trade-off occurs between the two or more kinds of costs. Therefore, the multi-objective optimization processing is used as the numerical analysis processing to obtain Pareto curved line or curves. Because the curved line or curved surface can be obtained for the partial problem for which the term substitution has been completed, data to illustrate the superimposed curved lines or curves is generated and outputted to the output device.

Although the embodiment of this technique was explained, this technique is not limited to this technique. For example, the functional block diagram illustrated in FIG. 1 is a mere example, and does not always correspond to the actual program module configuration. In addition, as for the processing flow, the step S9 maybe executed in parallel with the step S11, and the order may be exchanged.

Furthermore, at least one of the numerical analysis processing module 400, QE module 300 and simulator 200 and the information processing apparatus 100 may be implemented together on one computer. In addition, the information processing apparatus 100 may be implemented on plural computers.

In addition, the aforementioned information processing apparatus 100 is computer device as illustrated in FIG. 7. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 7. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The embodiments described above are summarized as follows:

An information processing method relating to this embodiment includes: (A) first generating a problem for a quantifier elimination method from data of a cost function representing a relationship between a parameter set and a cost, wherein the data of the cost function is stored in a data storage unit; (B) causing a first module that carries out a processing for the quantifier elimination method by term substitution to carry out the processing for the generated problem, to obtain a first processing result; (C) upon detecting that the first processing result includes data of a first partial problem for which the term substitution is impossible, causing a second module that carries out a numerical analysis processing to carry out a processing to minimize a cost for the first partial problem, to obtain a second processing result; (D) upon detecting that the first processing result includes a logical expression that is a solution of a second partial problem for which the term substitution has been completed, second generating first data to identify a minimum cost value from the logical expression; and (E) third generating second data representing a minimum cost for the problem from the second processing result and the first data generated when the second partial problem exists.

By carrying out such a processing, even for a problem for which no solution is obtained within a permissible time only by the computer algebra, a solution having some accuracy is obtained by merging the numerical analysis processing. In addition, the solution of the QE may be partially obtained. Furthermore, even when the numerical analysis processing is carried out, the partial problem is processed instead of the original or initial problem. In other words, because the number of variables to be searched is reduced since the term substitution is partially carried out, or a logical expression for which the term substitution is necessary for the variables to be eliminated has been determined, it is possible to reduce the processing time required for the numerical analysis processing.

Furthermore, the aforementioned information processing method may further include: (F) generating data representing the minimum cost for the problem from the second processing result, upon detecting that there is no second partial problem or the first data is not generated. Even when there is no second partial problem or the first data is not generated, at least one variable with the quantifier will be eliminated. Therefore, the search range of the variable to be searched in the numerical analysis processing is narrowed, and the processing time is shortened.

Incidentally, the aforementioned first data may include data of a value range of the cost or a minimum value within the value range of the cost, and the second processing result may include one or plural minimum cost values. In such a case, the second data may be a minimum cost value among the value range of the cost or the minimum cost value within the value range of the cost and the one or plural minimum cost values.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a procedure, the procedure comprising:
first generating a problem for a quantifier elimination method from data of a cost function representing a relationship between a parameter set and a cost;
causing a first module that carries out a processing for the quantifier elimination method by term substitution to carry out the processing for the generated problem, to obtain a first processing result;
upon detecting that the first processing result includes data of a first partial problem for which the term substitution is impossible, causing a second module that carries out a numerical analysis processing to carry out a processing to minimize a cost for the first partial problem, to obtain a second processing result;
upon detecting that the first processing result includes a logical expression that is a solution of a second partial problem for which the term substitution has been completed, second generating first data to identify a minimum cost value from the logical expression; and
third generating second data representing a minimum cost for the problem from the second processing result and the first data generated when the second partial problem exists.

2. The computer-readable, non-transitory storage medium as set forth in claim 1, the procedure further comprising:
generating data representing the minimum cost for the problem from the second processing result, upon detecting that there is no second partial problem.

3. The computer-readable, non-transitory storage medium as set forth in claim 1, wherein the first data includes data of a value range of the cost or a minimum value within the value range of the cost, and
the second processing result includes one or plural minimum cost values, and
the second data is a minimum cost value among the value range of the cost or the minimum cost value within the value range of the cost and the one or plural minimum cost values.

4. An information processing method, comprising:
first generating, by using a computer, a problem for a quantifier elimination method from data of a cost function representing a relationship between a parameter set and a cost;
causing, by using the computer, a first module that carries out a processing for the quantifier elimination method by term substitution to carry out the processing for the generated problem, to obtain a first processing result;
upon detecting that the first processing result includes data of a first partial problem for which the term substitution is impossible, causing, by using the computer, a second module that carries out a numerical analysis processing to carry out a processing to minimize a cost for the first partial problem, to obtain a second processing result;
upon detecting that the first processing result includes a logical expression that is a solution of a second partial problem for which the term substitution has been completed, second generating, by using the computer, first data to identify a minimum cost value from the logical expression; and
third generating second, by using the computer, data representing a minimum cost for the problem from the second processing result and the first data generated when the second partial problem exists.

5. An apparatus, comprising:
a memory; and
a processor using the memory and configured to execute a procedure, the procedure comprising:
first generating a problem for a quantifier elimination method from data of a cost function representing a relationship between a parameter set and a cost;
causing a first module that carries out a processing for the quantifier elimination method by term substitution to carry out the processing for the generated problem, to obtain a first processing result;
upon detecting that the first processing result includes data of a first partial problem for which the term substitution is impossible, causing a second module that carries out a numerical analysis processing to carry out a processing to minimize a cost for the first partial problem, to obtain a second processing result;
upon detecting that the first processing result includes a logical expression that is a solution of a second partial problem for which the term substitution has been completed, second generating first data to identify a minimum cost value from the logical expression; and
third generating second data representing a minimum cost for the problem from the second processing result and the first data generated when the second partial problem exists.
